(19) United States
(12) Patent Application Publication
(10) Pub. No.: US 2018/0165308 A1
(43) Pub. Date: Jun. 14, 2018

(54) DERIVING A DATA STRUCTURE FOR A PROCESS MODEL SOFTWARE

(71) Applicant: SAP SE, Walldorf (DE)

(72) Inventor: Harald Schubert, Mannheim (DE)

(21) Appl. No.: 15/376,296

(22) Filed: Dec. 12, 2016

(51) Int. Cl. G06F 17/30

(52) U.S. Cl. CPC G06F 17/30306; G06F 17/30345

(57) ABSTRACT

The present disclosure describes methods, systems, and computer program products for deriving a data structure for a processing model. One computer-implemented method includes receiving a first sample data set for a process model; deriving, by at least one hardware processor, a first data structure based on the first sample data set; receiving a second sample data set for the process model; and modifying, by the at least one hardware processor, the first data structure to generate a second data structure based on the second sample data set.

### BACKGROUND

A process model software can be used to manage a process flow. A process model can receive a request to initiate a process, execute one or more steps of process flow for the process, and terminate the process. In some cases, a process model be developed and operated according to a software specification, e.g., a Business Process Modeling Notation (BPMN) protocol.

### SUMMARY

The present disclosure describes methods and systems, including computer-implemented methods, computer program products, and computer systems for deriving a data structure for a processing model.

In an implementation, a computer-implemented method includes receiving a first sample data set for a process model; deriving, by at least one hardware processor, a first data structure based on the first sample data set; receiving a second sample data set for the process model; and modifying, by the at least one hardware processor, the first data structure to generate a second data structure based on the second sample data set.

The foregoing and other described implementations can each optionally include one or more of the following features, alone or in combination:

A first aspect, combinable with the general implementation, wherein modifying the first data structure comprises modifying a data type of the first data structure to match at least one sample data in the second sample data set.

A second aspect, combinable with the general implementation, wherein modifying the first data structure comprises contracting a data range of the first data structure based on sample data in the first sample data set and the second sample data set.

A third aspect, combinable with the general implementation, further comprising: displaying, at least one of the first data structure or the second data structure; receiving a user input for data structure modification; and modifying the at least one of the first or the second data structure based on the user input.

A fourth aspect, combinable with the general implementation, wherein the first data structure is derived based on a reference expression.

A fifth aspect, combinable with the general implementation, wherein the second data structure is used to generate a validation rule.

A sixth aspect, combinable with the general implementation, wherein the second data structure is used to generate a form for data input.

The above-described implementation is implementable using a computer-implemented method; a non-transitory, computer-readable medium storing computer-readable instructions to perform the computer-implemented method; and a computer system comprising a computer memory interoperably coupled with a hardware processor configured to perform the computer-implemented method/the instructions stored on the non-transitory, computer-readable medium.

The subject matter described in this specification can be implemented in particular implementations so as to realize one or more of the following advantages. For example, the described approach can generate a data structure automatically based on a sample data set and refine the generated data structure based on additional sample data sets automatically. Therefore, the described approach reduces complexities in defining a data structure in a process model by avoiding the complexities associated in learning and using specific language. In some cases, this approach also provides a flexible way to review and refine the data structure by providing a formal specification of data structure if sample data sets do not provide for sufficient accuracy. Moreover, the sample data sets can also be reused as data inputs for automated tests. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a flow diagram illustrating a process flow 100 executed by a process model, according to an implementation.

FIG. 2 is a flow diagram illustrating a data operation process executed by a process model, according to an implementation.

FIG. 3 is a flow diagram of a computer-implemented method that derives a data structure, according to an implementation.

FIG. 4 is a schematic diagram illustrating a composite data structure derivation process, according to an implementation.

FIG. 5 is a schematic diagram illustrating interaction of an example process model with other models, according to an implementation.

FIG. 6 is a block diagram of an exemplary computer system 600 used to provide computational functionalities associated with described algorithms, methods, functions, processes, flows, and procedures as described in the instant disclosure, according to an implementation.

Like reference numbers and designations in the various drawings indicate like elements.

### DETAILED DESCRIPTION

The following detailed description describes deriving a data structure for a processing model and is presented to enable any person skilled in the art to make and use the disclosed subject matter in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

In some cases, executable process flow can be formalized by a developer of a process model. During the formalization, a developer can use a data definition language (DDL) such as XML Schema (XSD) or JavaScript Object Notation (JSON) Schema to express the data format of possible input data to the process model. It's often a time-consuming process to learn the DDL and manually express the data formats using the DDL. Furthermore, the manual expression of the data formats may not be robust enough to accommodate data from a large data source.

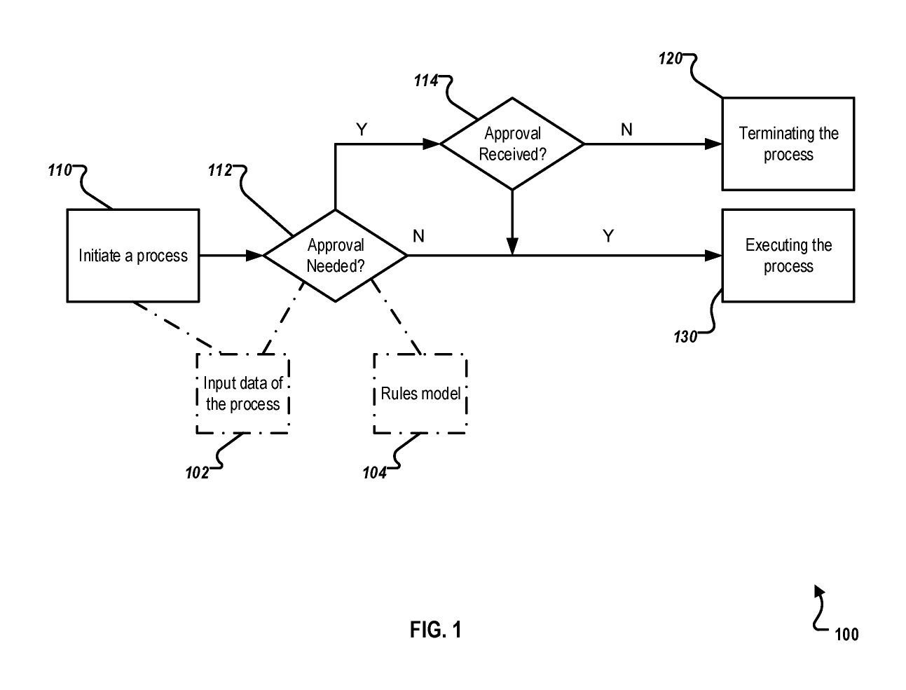

In some implementations, data structures for input data can be derived based on sample data sets. Data types and data ranges can be learned from sample data in the sample data sets and the data structures can be generated automatically based on the sample data. Therefore, a developer can automate the formalization process using sample data. In some cases, the developer can input a large amount of sample data to create a robust data structure, which may not be achievable using manual expression. Furthermore, the generated data structure can be modified based on additional sample data, and therefore provides flexibility and robustness to the formalization process. FIGS. 1-6 and associated descriptions provide additional details of these implementations.

FIG. 1 is a flow diagram illustrating a process flow 100 executed by a process model, according to an implementation. As illustrated, at 110, a user initiates a process using a process model. In one example, the process can be a manufacturing process. The process model can receive input data 102 associated with the process that is initiated. The input data 102 can be entered by the user, or retrieved from a database, a data file, or any source of data. The input data 102 can include data related to the project manager of the process, resources of the process, target completion of the process, or any other information related to the process.

The process model can determine the processing step for the process. For example, the process model can retrieve rules model 104 that is associated with the manufacturing process. The rules model 104 can include rules related to approval of the manufacturing process. For example, the rules model 104 can include a rule that requires approval for a manufacturing process initiated by a project manager with an authority level below a first threshold, a manufacturing process that requires resources above a second threshold, or a combination thereof. At 112, the process model can determine whether the process requires approval based on the rules model 104. If the process does not require approval, the process flow 100 proceeds from 112 to 130, where the process model executes the process. For example, the process model can initiate resource allocation, schedule development, documentation, or any other operations related to the process. If the process requires approval, the process flow 100 proceeds to 114, where the process model requests approval. In some cases, the process model can require approval by sending an approval request via email, text, or a portal, to an authorized approver. If an approval is received, the process flow 100 proceeds from 114 to 130, where the process model executes the process. If the approval is not received, the process flow 100 proceeds from 114 to 120, where the process model terminates the process.

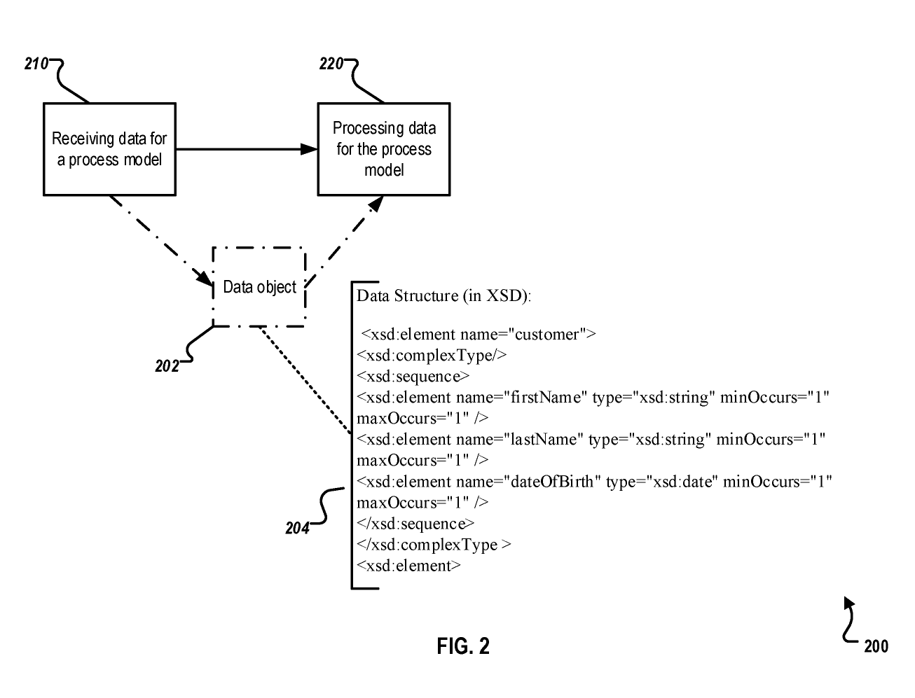

FIG. 2 is a flow diagram illustrating a data operation process 200 executed by a process model, according to an implementation. In some cases, a process model may include more than one executable processing steps. These executable processing steps may operate on a common data set. As illustrated, at 210, data are received by the process model. The data may be stored as a data object 202. The data object 202 may have a data structure 204. For example, as described previously, the data can be an order to initiate a manufacturing process, the data object 202 can include data about the worker that is responsible for the manufacturing process, the data about the estimated completion time of the manufacturing process, the resources requested for the manufacturing process, or any other data related to the manufacturing process. The data object 202 can be stored in the format of one or more data structures 204. The data structures 204 can include one or more data types, e.g., a string, an integer, a Boolean variable, date, time, or the like. The data structures 204 can also include one or more ranges for the data, e.g., a continuous range or an enumerated set. In some cases, the data structures 204 can include a composite data structure. For example, the data structures 204 can include a phone number data structure. The phone number data structure can include one or more sub data structures including e.g., area code, number, extension, and etc. Each of the sub data structures can have a data type, a data range, or a combination thereof.

At 220, the data object 202 can be processed by the process model. For example, the process model can determine whether an approval is needed, whether to execute the next step, and etc. In some cases, the process model can be implemented using a data object-driven technique. For example, the process model can automate one or more processing operations based on the data structure 204 of the data object 202. Examples of these automated processing operations include selecting different processing procedures, mapping validation rules, defining visibility models such as measures and key performance indicators (KPIs), defining vocabulary models such as processing rules, developing content assist functions when developing scripts embedded in a process flow, and presenting form models that express user interfaces for the process flow.

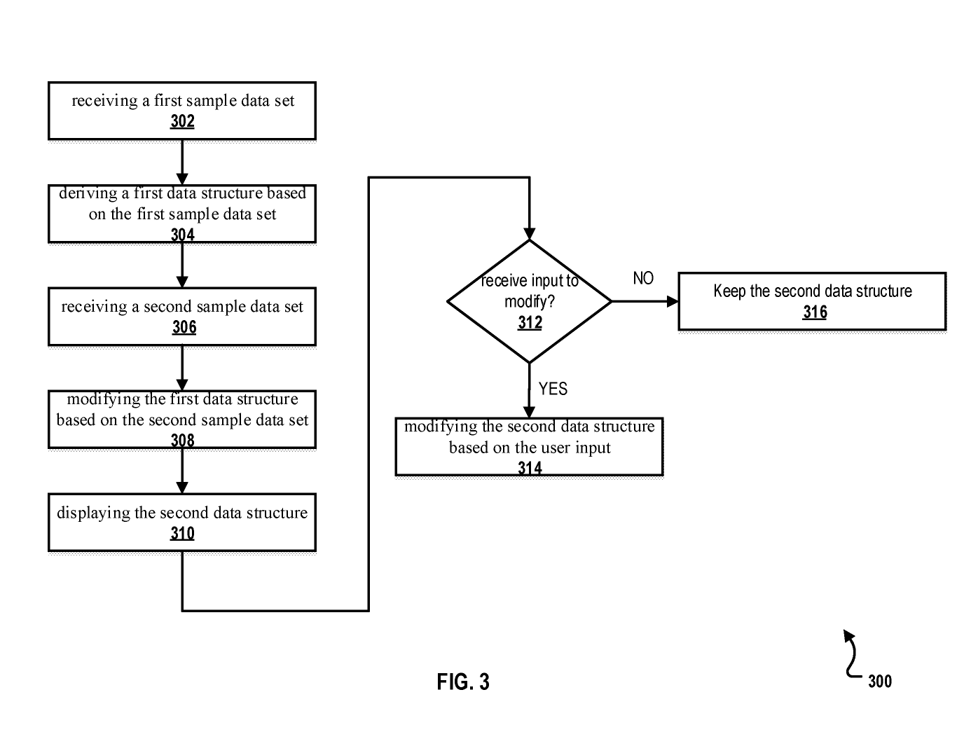

FIG. 3 is a flow diagram of a computer-implemented method 300 that derives a data structure, according to an implementation. For clarity of presentation, the description that follows generally describes method 300 in the context of FIGS. 1-2 and 4-6. However, it will be understood that method 300 may be performed, for example, by any other suitable system, environment, software, and hardware, or a combination of systems, environments, software, and hardware, as appropriate. In some implementations, various steps of method 300 can be run in parallel, in combination, in loops, and/or in any order.

At 302, a first sample data set for the process model is received. The first sample data set can include one or more sample data. In some cases, the first sample data set can be inputted by a developer of the process model. Alternatively, or additionally, the first sample data set can be extracted from a database record, a data file, or any other source of data. Following is an example of one sample data in the first sample data set:

Project Manager Info:

id: 56473927465749

firstName: John

lastName: Smith

dateOfBirth: 1978-10-24

authority level: 1

digital Signature: >
04:a0:15:32:a3:c0:90:00:53:de:60:fb:efefcc:
a5:87:93:30:15:98:d3:08:b4:1e:6f4e:36:4e:38:
8c:27:11:bef4:32:c5:99:14:8c:94:14:3d:4f:f4:
6c:2c:b7:3e:3e:6a:41:d7:ee:f2:3c:04:7e:a1:1e:
60:66:7d:e4:25

address:
street: Downing Street
streetNo: 10
town: London
postalCode: SW1A 2AA
country: United Kingdom

phones:
name: home
   countryCode: +44
   areaCode: 20
   number: 7946 0631
   extension: 0
name: business
   countryCode: +44
   areaCode: 20
   number: 7946 2456
   extension: 1.
      At 304, a first data structure is derived based on the first sample data set. In some cases, the sample data in the first sample data set can be analyzed and a data structure can be derived automatically using reference data pattern matching.

Table 1 illustrates an example reference data pattern table:

TABLE 1

| Data Type | Reference Expression | Example(s) |
|---|---|---|
| boolean | (yes\|no\|true\|false) | yes, no |
| integer | [0-9]{1,10} | 25354637 |
| long | ([0-9]{1,10}[1L]\|[0-9]{11,}[1L]?) | 2635464748459573, |
| | | 2359573L |
| decimal | (($\|£\|¥\| . . . )?[0-9]+\.[0-9]{2}(€\| . . . )?\| | 24.54€, 232.03, 234.345m |
| | [0-9]+(\.[0-9]+)?[mM]) | |
| float | ([0-9]+\.[0-9]+[fF]?\|[0-9]+[fF]) | 26364.2737, 47473.2634f, 3f |
| double | ([0-9]+\.[0-9]+[dD]?\|[0-9]+[dD]) | 475757.1234, 45678.234D, 5D |
| date | [0-9]{4}\-[0-9]{2}\-[0-9]{2} | 2016-10-23 |
| date time | [0-9]{4}\-[0-9]{2}\-[0-9]{2}(T\| ) | 2016-10-23 22:12:33 |
| | [0-9]{2}\:[0-9]{2}\:[0-9]{2}(\.[0-9]{3}Z)? | 2016-10-23T22:12:33.123Z |
| binary | [0-9a-fA-F]{2}(:[0-9a-fA-F]{2})* | a5:87:93:30:15 |
| character | \‘?.\’? | c, ‘c’ |
| email | [0-9a-z.+\-_]+@[0-9a-z.+\-_]+\.[a-z]{2,4} | name@example.org |
| url | ((https?\|ftp):\/\/)?[0-9a-z]([0-9a-z\-]*[0-9a- | http://example.org |
| | z])?(\.[0-9a-z]([0-9a-z\-]*[0-9a- | |
| | z])?)+(:\d{0,5}) | |
| telephone | \+(?:[0-9]\W*){6,14}[0-9] | +44 (20) 7946 2456-0 |
| string | \“?.+\”? | John Smith, “John Smith” |

As illustrated in Table 1, a data type can have a corresponding reference expression. A data type of a sample data can be determined by matching the sample data with the reference expressions. If the sample data matches a reference expression, the corresponding data type can be selected as the data type for the sample data.

In some cases, a data range for sample data can also be determined. The data range can be continuous. For example, the dates of birth for the sample data in the first sample data set are between January, 1940, and January, 1990, then the data range for the data of birth can be determined as from January, 1940 to January, 1990. The data range can also be an enumerated set. For example, if country code for all the sample data in the first sample data set is “44,” then the data range of the country code can be one number: 44. In some cases, the determined data range can be used to develop validation rules. The validation rules can be used to alert a data entry error if an entered data exceeds the data range. Error! Hyperlink reference not valid.

In some cases, a statistical approach can be used to derive data type, data range, or a combination thereof based on data in the sample data set. Following is an example procedure of determining whether the data range is an enumerated set based on the data values in the sample data set:

1. Calculate a quality ratio Q of the data values in the data sample set based on the number of total data and the number of different data values. In one example, Q=# total values/# different values. In this example, if there are 50 data samples in the data sample sets, and theses 50 data samples have 20 different data values, Q=50/20=2.5.

2. If Q exceeds a configured threshold Tq, the data range is determined to be an enumerated set. Further, the elements of the enumerated set can be determined by including the different data values. In some cases, the enumerated set can be refined by excluding the outliers. For example, if the number of sample data that take a particular data value does not exceed a configured relative frequency threshold Tr, the particular data value is not included in the enumerated set.

3. If Q does not exceed the configured threshold Tq, then the data range is determined not to be an enumerated set.

In some cases, the thresholds Tq and Tr can be configured by the developer of the process model. While the process model generates the derived data structure based on the algorithms described above, the thresholds can be modified. In some cases, machine learning (ML) techniques can be used to refine the thresholds.

Following is another example procedure of determining a data type based on the data values of sample data in the sample data set:

1. Identify character classes based on common patterns, e.g., [0-9], [a-zA-Z], [-_.,;], at each position of a data value of a sample data. In some cases, heuristics or machine learning can be used in the identification process.

2. Derive a regular expression that fits the determined common pattern. For example, if the common patterns of the data values are [0-9], the regular expression can be derived as [0-9] {1,10}.

3. Match a data type with the regular expression. For example, if the derived regular expression is [0-9]{1,10}, the data type is determined as an integer.

4. If no fitting regular expression is derived, the data type can be determined as a string.

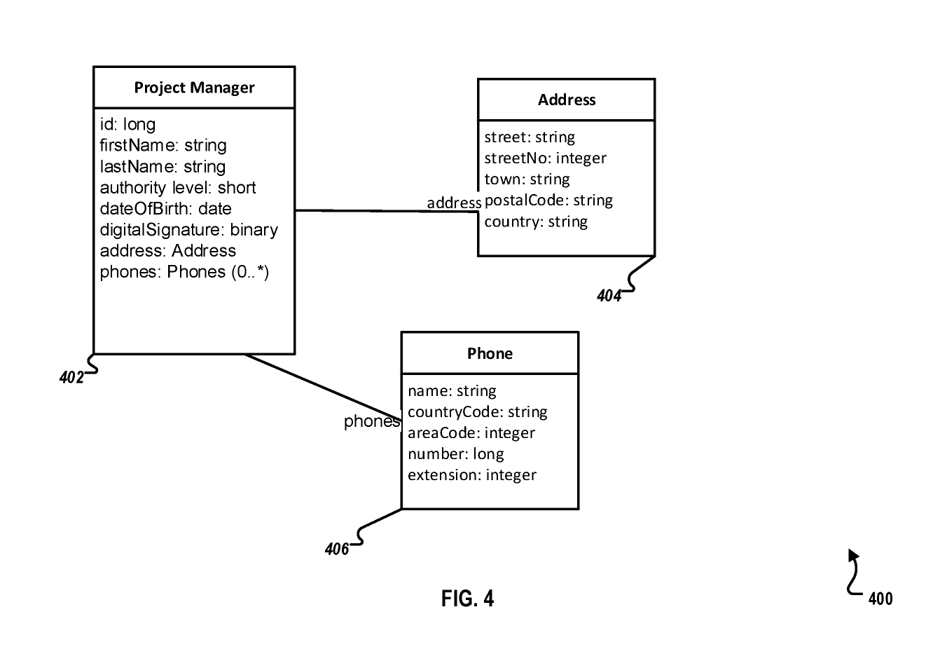

FIG. 4 is a schematic diagram 400 illustrating a composite data structure derivation process, according to an implementation. In some cases, a composite data structure can be derived. As illustrated, a project manager data structure 402 can include an ID data structure, a firstName data structure, a lastName data structure, an authority level data structure and etc. The id data structure can have a data type of long integer. Both the firstName and the lastName data structures can have a data type of string. The authority level data structure can have a data type of a short integer. The project manager data structure 402 can also include an address data structure 404 and a phone data structure 406. The address data structure 404 can include data structures such as street, streetNo, town, and etc. The phone data structure 406 can include data structures such as name, country code, area code and etc.

Returning back to FIG. 3, in some cases, the initial data structure generated based on the first sample data set can be refined by additional sample data sets. At 306, a second sample data set is received. The second sample data set can be inputted by a developer, or extracted from a database record, a data file, or any other source of data.

At 308, the first data structure is modified based on the second sample data set to generate a second data structure. In some cases, the sample data in the second sample data set can be analyzed and compared with the first data structure to determine whether the sample data matches the first data structure. For example, the second sample data set can include information of a different project manager. The information of a different project manager can be matched with the project manager data structure generated based on the first sample data set. If all the data entries in the information of a different project manager match the project manager data structure, the project manager data structure does not have to be modified. If at least one data entry in the information of a different project manager does not match the project manager data structure, then the project manager data structure is modified to accommodate the unmatched data entry. In one example, if the information of a different project manager includes a department name that has not been included in the project manager data structure, the project manager data structure can be expanded to include a department name data structure, and a data type of string can be assigned to the department name data structure.

In some cases, the first data structure can be modified by changing a data type associated with the first data structure or a sub data structure within the first data structure. For example, as illustrated in FIG. 4, the streetNo in the address data structure 404 based on the first sample data set is assigned a data type of integer. In this example, the address of a different project manager in the second sample data set can have a street number of “10b,” which is not an integer. Based on the mismatches between the additional sample data and the first data structure, the data type of the streetNo in the address data structure 404 can be modified to a string.

Alternatively, or additionally, the first data structure can be modified by expanding a data range associated with the first data structure or a sub data structure within the first data structure. In one example, as described previously, the data range for the date of birth can be determined as from January, 1940 to January, 1990 based on the first data structure. However, the date of birth of a different project manager in the second sample data set may be March, 1992. Therefore, the data range for the data of birth can be expanded to between January, 1940 and March, 1992. In another example, the data range of the country code for the first data structure is one number: 44. However, the country code of a different project manager in the second sample data set may be +1. Therefore, the data range for the country code can be expanded to a set of {1, 44}.

In some cases, the sample data in the second sample data set can be analyzed to derive a temporary data structure using reference data pattern matching, described previously. The first data structure can be modified by unionizing the temporary data structure and the first data structure.

In some cases, the first data structure can be contracted based on the second sample data set. For example, the data range can be determined based on the values of sample data and the number of sample data. If the number of sample data does not exceed a configured threshold, a broad data range may be defined. For example, if the first sample data set includes the information of six project managers having authority levels of either 1 or 2, the number of samples may not be large enough to define a narrow data range: e.g., between 1 and 2. Instead, the data range may set as 0 to infinity. If the second sample data set includes the information of fifteen additional project managers, who all have authority levels of either 1 or 2, and the configured threshold is twenty, then the data range for the authority level can be narrowed to between 1 and 2, or an enumerated set of {1, 2}. In another example, the data range of the first data structure can be determined based on statistic parameters of the sample data in the first sample data set, e.g., the mean and the variance of the sample data. By analyzing additional sample data in the second sample data set, the data range can be modified using the statistic parameters of the sample data in both the first and the second sample data set.

In some cases, a statistical approach that is used to modify the first data structure. For example, the procedure described previously on determining a data range and data type can be used to determine the second data structure based on the sample data in the first and the second sample data sets.

In some cases, a developer can review the generated data structures and further refine the generated data structure. For example, at 310, the second data structure is displayed. The developer can review the displayed data structure and select a user input to modify the displayed data structure. The user input can be selected using a click, a keyboard entry, a touch, a swap, or any other user interface interactions. At 312, whether a user input is received for modification is determined. If a user input for modification is received, the method 300 proceeds from 312 to 314, where the second data structure is modified based on the user input. For example, the developer can change a data type, a data range, or a combination thereof. In some cases, the developer can also overwrite a data structure or enter a new data structure if the automatically generated data structure is not sufficient. For example, the developer can input the data structure using a reference expression in Table 1 or any other regular expression. If a user input for modification is not received at 312, the method 300 proceeds from 312 to 316, where the second data structure can be kept. In some cases, a developer can enter a user input to confirm the displayed second data structure without modification. Alternatively, or additionally, the developer can refrain from entering a user input for modification, and the displayed second data structure can be kept after a time out. In some cases, a developer can review and modify the derived data structure before the data structure is modified based on the second sample data. For example, the developer can review and modify the first data structure. The modified data structure can further be refined using additional sample data sets.

In some cases, a sample data set, e.g., the first sample data set or the second sample data set can include annotated sample data. The annotated sample data can use embedding type information, e.g., prefixes or suffixes. For example, numbers like 2.0 f, 2.0 d, 2.0 m can be included to distinguish types or ranges of data values. The annotated sample data can also use reference expressions such as those defined in Table 1. This approach can provide a generalized data sample and improve the accuracy of the derived data structure. In some cases, a sample data set, e.g., the first sample data set, the second sample data set, or a combination thereof can be used as test data that can be used to input to the process model in automated test.

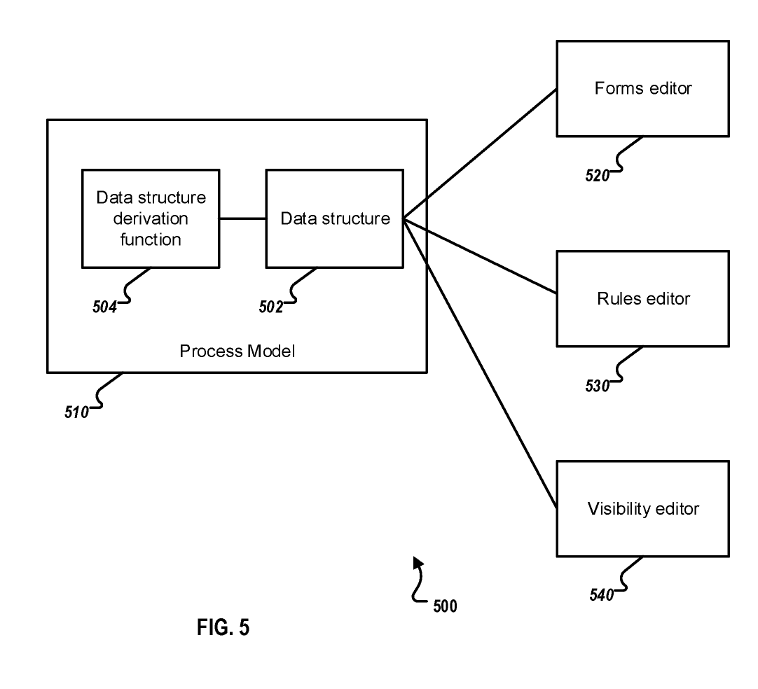

FIG. 5 is a schematic diagram 500 illustrating interaction of an example process model with other models, according to an implementation. The schematic diagram 500 includes a process model 510. The process model 510 represents an application, set of applications, software, software modules, hardware, or combination of software and hardware that can be used to manage a process flow. As described previously, the process model 510 can receive a request to initiate a process, execute one or more steps of process flow for the process, and terminate the process. In some cases, the process model 510 can be configured to execute a process according to a Business Process Modeling Notation (BPMN) language.

The process model 510 includes a data structure derivation function 504. The data structure derivation function 504 represents an application, set of applications, software, software modules, hardware, or combination of software and hardware that can be used to derive one or more data structures 502. As described previously, the data structure derivation function 504 can derive the data structures 502, based on one or more sample data sets. In some cases, the data structure derivation function 504 can also receive user inputs from a developer to modify the derived data structures.

The forms editor 520 represents an application, set of applications, software, software modules, hardware, or combination of software and hardware that can be used to generate a user interface for data input. For example, a developer can use the forms editor 520 to customize a form for a particular data input, e.g., a form for project manager information data input. In some cases, the forms editor 520 can access the data structure 502 to determine the data type and data range of the data for the project manager information and generate the form accordingly.

The rules editor 530 represents an application, set of applications, software, software modules, hardware, or combination of software and hardware that can be used to generate rules for a process. For example, a developer can use the rules editor 530 to generate rules associated with a particular process and one or more decision tables based on the rules. Examples of the rules can include rules related to approving a process. In some cases, the rules editor 530 can access the data structure 502 in generating the rules. For example, the rules editor 530 can retrieve the data range of the authority levels of the project manager data, and generate different rules for different authority levels.

The visibility editor 540 represents an application, set of applications, software, software modules, hardware, or combination of software and hardware that can be used to generate process dashboards. Examples of process contexts include metrics and key performance of a process. A developer can use the visibility editor 540 to customize the process dashboards for a process. In some cases, the visibility editor 540 can access the data structure 502 in generating process dashboards. For example, the visibility editor 540 can retrieve the data range of the completion time of a process, and generate performance metrics based on the data range.

While portions of the software elements illustrated in FIG. 5 are illustrated as individual modules that implement the various features and functionality through various objects, methods, or other processes, the software can instead include a number of sub-modules, third-party services, components, libraries, and such, as appropriate. Conversely, the features and functionality of various components can be combined into single components as appropriate.

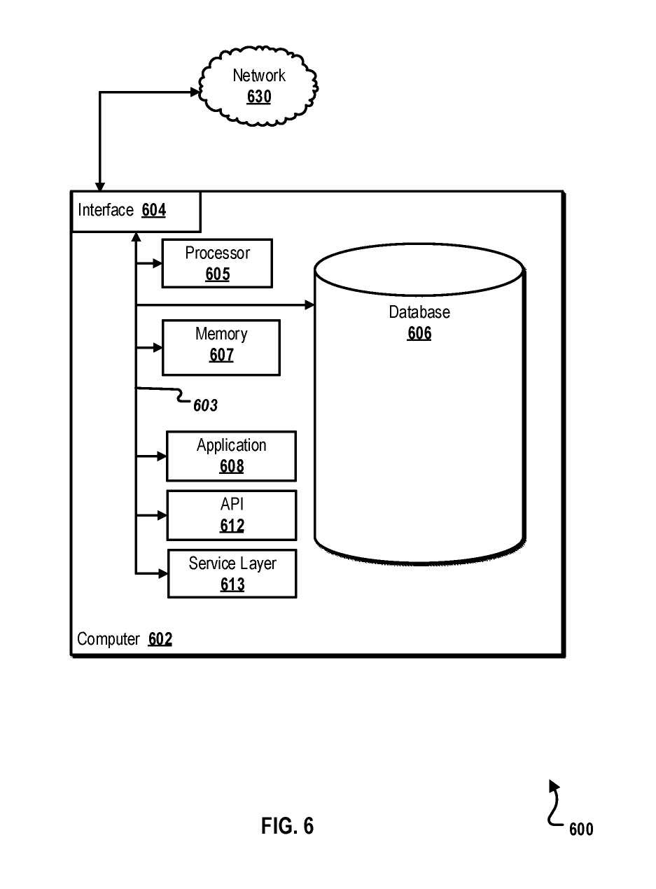

FIG. 6 is a block diagram of an exemplary computer system 600 used to provide computational functionalities associated with described algorithms, methods, functions, processes, flows, and procedures as described in the instant disclosure, according to an implementation. The illustrated computer 602 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 602 may comprise a computer that includes an input device, such as a keypad, keyboard, touch screen, or other device that can accept user information, and an output device that conveys information associated with the operation of the computer 602, including digital data, visual, or audio information (or a combination of information), or a GUI.

The computer 602 can serve in a role as a client, network component, a server, a database or other persistency, or any other component (or a combination of roles) of a computer system for performing the subject matter described in the instant disclosure. The illustrated computer 602 is communicably coupled with a network 630. In some implementations, one or more components of the computer 602 may be configured to operate within environments, including cloud-computing-based, local, global, or other environment (or a combination of environments).

At a high level, the computer 602 is an electronic computing device operable to receive, transmit, process, store, or manage data and information associated with the described subject matter. According to some implementations, the computer 602 may also include or be communicably coupled with an application server, e-mail server, web server, caching server, streaming data server, business intelligence (BI) server, or other server (or a combination of servers).

The computer 602 can receive requests over network 630 from a client application (for example, executing on another computer 602) and respond to the received requests by processing the said requests in an appropriate software application. In addition, requests may also be sent to the computer 602 from internal users (for example, from a command console or by another appropriate access method), external or third-parties, other automated applications, as well as any other appropriate entities, individuals, systems, or computers.

Each of the components of the computer 602 can communicate using a system bus 603. In some implementations, any or all of the components of the computer 602, both hardware or software (or a combination of hardware and software), may interface with each other or the interface 604 (or a combination of both) over the system bus 603 using an application programming interface (API) 612 or a service layer 613 (or a combination of the API 612 and service layer 613). The API 612 may include specifications for routines, data structures, and object classes. The API 612 may be either computer-language independent or dependent and refer to a complete interface, a single function, or even a set of APIs. The service layer 613 provides software services to the computer 602 or other components (whether or not illustrated) that are communicably coupled to the computer 602. The functionality of the computer 602 may be accessible for all service consumers using this service layer. Software services, such as those provided by the service layer 613, provide reusable, defined business functionalities through a defined interface. For example, the interface may be software written in JAVA, C++, or other suitable language providing data in extensible markup language (XML) format or other suitable format. While illustrated as an integrated component of the computer 602, alternative implementations may illustrate the API 612 or the service layer 613 as stand-alone components in relation to other components of the computer 602 or other components (whether or not illustrated) that are communicably coupled to the computer 602. Moreover, any or all parts of the API 612 or the service layer 613 may be implemented as child or sub-modules of another software module, enterprise application, or hardware module without departing from the scope of this disclosure.

The computer 602 includes an interface 604. Although illustrated as a single interface 604 in FIG. 6, two or more interfaces 604 may be used according to particular needs, desires, or particular implementations of the computer 602. The interface 604 is used by the computer 602 for communicating with other systems in a distributed environment, that are connected to the network 630 (whether illustrated or not). Generally, the interface 604 comprises logic encoded in software or hardware (or a combination of software and hardware) and operable to communicate with the network 630. More specifically, the interface 604 may comprise software supporting one or more communication protocols associated with communications such that the network 630 or interface's hardware is operable to communicate physical signals within and outside of the illustrated computer 602.

The computer 602 includes a processor 605. Although illustrated as a single processor 605 in FIG. 6, two or more processors may be used according to particular needs, desires, or particular implementations of the computer 602. Generally, the processor 605 executes instructions and manipulates data to perform the operations of the computer 602 and any algorithms, methods, functions, processes, flows, and procedures as described in the instant disclosure.

The computer 602 also includes a database 606 that can hold data for the computer 602 or other components (or a combination of both) that can be connected to the network 630 (whether illustrated or not). For example, database 606 can be an in-memory, conventional, or other type of database storing data consistent with this disclosure. In some implementations, database 606 can be a combination of two or more different database types (for example, a hybrid in-memory and conventional database) according to particular needs, desires, or particular implementations of the computer 602 and the described functionality. Although illustrated as a single database 606 in FIG. 6, two or more databases (of the same or combination of types) can be used according to particular needs, desires, or particular implementations of the computer 602 and the described functionality. While database 606 is illustrated as an integral component of the computer 602, in alternative implementations, database 606 can be external to the computer 602.

The computer 602 also includes a memory 607 that can hold data for the computer 602 or other components (or a combination of both) that can be connected to the network 630 (whether illustrated or not). For example, memory 607 can be random access memory (RAM), read-only memory (ROM), optical, magnetic, and the like storing data consistent with this disclosure. In some implementations, memory 607 can be a combination of two or more different types of memory (for example, a combination of RAM and magnetic storage) according to particular needs, desires, or particular implementations of the computer 602 and the described functionality. Although illustrated as a single memory 607 in FIG. 6, two or more memories 607 (of the same or combination of types) can be used according to particular needs, desires, or particular implementations of the computer 602 and the described functionality. While memory 607 is illustrated as an integral component of the computer 602, in alternative implementations, memory 607 can be external to the computer 602.

The application 608 is an algorithmic software engine providing functionality according to particular needs, desires, or particular implementations of the computer 602, particularly with respect to functionality described in this disclosure. For example, application 608 can serve as one or more components, modules, applications, etc. Further, although illustrated as a single application 608, the application 608 may be implemented as multiple applications on the computer 602. In addition, although illustrated as integral to the computer 602, in alternative implementations, the application 608 can be external to the computer 602.

There may be any number of computers 602 associated with, or external to, a computer system containing computer 602, each computer 602 communicating over network 630. Further, the term “client,” “user,” and other appropriate terminology may be used interchangeably as appropriate without departing from the scope of this disclosure. Moreover, this disclosure contemplates that many users may use one computer 602, or that one user may use multiple computers 602.

Described implementations of the subject matter can include one or more features, alone or in combination, relates to computer-implemented methods, computer-readable media, and computer systems for deriving data structures of a process model. One computer-implemented method includes receiving a first sample data set for a process model; deriving, by at least one hardware processor, a first data structure based on the first sample data set; receiving a second sample data set for the process model; and modifying, by the at least one hardware processor, the first data structure to generate a second data structure based on the second sample data set.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

The foregoing and other described implementations can each optionally include one or more of the following features, alone or in combination:

A first aspect, combinable with the general implementation, wherein modifying the first data structure comprises modifying a data type of the first data structure to match at least one sample data in the second sample data set.

A second aspect, combinable with the general implementation, wherein modifying the first data structure comprises contracting a data range of the first data structure based on sample data in the first sample data set and the second sample data set.

A third aspect, combinable with the general implementation, further comprising: displaying, at least one of the first data structure or the second data structure; receiving a user input for data structure modification; and modifying the at least one of the first or the second data structure based on the user input.

A fourth aspect, combinable with the general implementation, wherein the first data structure is derived based on a reference expression.

A fifth aspect, combinable with the general implementation, wherein the second data structure is used to generate a validation rule.

A sixth aspect, combinable with the general implementation, wherein the second data structure is used to generate a form for data input.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are illustrated as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate. Thresholds used to make computational determinations can be statically, dynamically, or both statically and dynamically determined.

The methods, processes, logic flows, etc. described in this specification can be performed by one or more programmable computers executing one or more computer programs to perform functions by operating on input data and generating output. The methods, processes, logic flows, etc. can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order illustrated or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, for deriving data structures of a process model, comprising:
receiving a first sample data set for a process model;
deriving, by at least one hardware processor, a first data structure based on the first sample data set;
receiving a second sample data set for the process model; and
modifying, by the at least one hardware processor, the first data structure to generate a second data structure based on the second sample data set.

2. The method of claim 1, wherein modifying the first data structure comprises modifying a data type of the first data structure to match at least one sample data in the second sample data set.

3. The method of claim 1, wherein modifying the first data structure comprises contracting a data range of the first data structure based on sample data in the first sample data set and the second sample data set.

4. The method of claim 1, further comprising:
displaying, at least one of the first data structure or the second data structure;
receiving a user input for data structure modification; and
modifying the at least one of the first or the second data structure based on the user input.

5. The method of claim 1, wherein the first data structure is derived based on a reference expression.

6. The method of claim 1, wherein the second data structure is used to generate a validation rule.

7. The method of claim 1, wherein the second data structure is used to generate a form for data input.

8. A non-transitory computer-readable medium storing one or more instructions executable by a computer system to perform operations comprising:
receiving a first sample data set for a process model;
deriving, by at least one hardware processor, a first data structure based on the first sample data set;
receiving a second sample data set for the process model; and
modifying, by the at least one hardware processor, the first data structure to generate a second data structure based on the second sample data set.

9. The non-transitory computer-readable medium of claim 8, wherein modifying the first data structure comprises modifying a data type of the first data structure to match at least one sample data in the second sample data set.

10. The non-transitory computer-readable medium of claim 8, wherein modifying the first data structure comprises contracting a data range of the first data structure based on sample data in the first sample data set and the second sample data set.

11. The non-transitory computer-readable medium of claim 8, the operations further comprising:
displaying, at least one of the first data structure or the second data structure;
receiving a user input for data structure modification; and
modifying the at least one of the first or the second data structure based on the user input.

12. The non-transitory computer-readable medium of claim 8, wherein the first data structure is derived based on a reference expression.

13. The non-transitory computer-readable medium of claim 8, wherein the second data structure is used to generate a validation rule.

14. The non-transitory computer-readable medium of claim 8, wherein the second data structure is used to generate a form for data input.

15. A computer system, comprising:
a computer memory; and
at least one hardware processor interoperably coupled with the computer memory and configured to perform operations comprising:
receiving a first sample data set for a process model;
deriving, by at least one hardware processor, a first data structure based on the first sample data set;
receiving a second sample data set for the process model; and
modifying, by the at least one hardware processor, the first data structure to generate a second data structure based on the second sample data set.

16. The computer system of claim 15, wherein modifying the first data structure comprises modifying a data type of the first data structure to match at least one sample data in the second sample data set.

17. The computer system of claim 15, wherein modifying the first data structure comprises contracting a data range of the first data structure based on sample data in the first sample data set and the second sample data set.

18. The computer system of claim 15, the operations further comprising:
displaying, at least one of the first data structure or the second data structure;
receiving a user input for data structure modification; and
modifying the at least one of the first or the second data structure based on the user input.

19. The computer system of claim 15, wherein the first data structure is derived based on a reference expression.

20. The computer system of claim 15, wherein the second data structure is used to generate a validation rule.
